(19) United States
(12) Patent Application Publication
(10) Pub. No.: US 2011/0211891 A1
(43) Pub. Date: Sep. 1, 2011

(54) POST-PROCESSING APPARATUS AND IMAGE FORMING APPARATUS

(75) Inventor: Shigeaki Nakamura, Osaka (JP)

(73) Assignee: KYOCERA MITA CORPORATION, Osaka (JP)

(21) Appl. No.: 13/016,803

(22) Filed: Jan. 28, 2011

(30) Foreign Application Priority Data
Feb. 26, 2010 (JP) 2010-041163

(51) Int. Cl. G03G 15/00; B26D 5/20

(52) U.S. Cl. 399/407; 83/367

(57) ABSTRACT

A post-processing apparatus includes a second sheet conveying portion that conveys a paper sheet, a movement portion that displaces in a displacement direction that is different from the conveying direction of the paper sheet in the second conveying portion, a sheet edge detection portion that is disposed on the movement portion and detects the position of the paper sheet, a punching processing portion that is disposed on the movement portion, and that executes a punching process at a predetermined position on the paper sheet based on the position of the paper sheet detected by the sheet edge detection portion, and a post-processing control portion that controls the second sheet conveying portion to stop the conveying of the paper sheet when the sheet edge detection portion detects that the paper sheet is positioned on an abnormal conveying path that diverges from a normal conveying path within a conveying path region.

This application is based on and claims the benefit of priority from Japanese Patent Application No. 2010-041163, filed on Feb. 26, 2010, the content of which is incorporated herein by reference.

### BACKGROUND OF THE INVENTION

1. Field of the Invention

The present invention relates to a post-processing apparatus performing a punching process at a predetermined position on an image forming medium such as a paper sheet, and to an image forming apparatus provided with the post-processing apparatus.

2. Related Art

A known conventional post-processing apparatus includes a punching portion that has a punch processing portion that forms a punching hole in paper sheet conveyed from an image forming apparatus, a sheet edge detection portion that detects an end of the paper sheet to thereby execute a punching process at a predetermined position on the paper sheet, and a movement portion that displaces the punching processing portion and the sheet edge detection portion in a direction that is orthogonal to the conveying direction of the paper sheet. This type of conventional post-processing apparatus is configured to firstly displace the movement portion to a position at which a punching process can be executed by the punching processing portion, and then stop the conveyance of the paper sheet when the paper sheet cannot be detected by the sheet edge detection portion.

This type of conventional post-processing apparatus does not have an allowance when the paper sheet is detected prior to displacement of the movement portion to a position at which the punching process can be executed by the punching processing portion. Thus there is a possibility of a paper sheet jam in this type of conventional post-processing apparatus when the paper sheet is conveyed after deviating from a position at which the punching process can be executed.

The present invention is proposed in light of the above problems, and has the object of providing a post-processing apparatus that enables suppression of jamming of an image forming medium such as paper sheet, or the like. The present invention has the further object of providing an image forming apparatus that includes the post-processing apparatus.

### SUMMARY OF THE INVENTION

The present invention relates to a post-processing apparatus that executes a punching process at a predetermined position of an image forming medium which is discharged from an image forming apparatus main body that executes forming of an image. The post-processing apparatus includes a conveying portion that conveys the image forming medium, a movement portion that displaces in a displacement direction that is different from the conveying direction of the image forming medium on the conveying portion, a position detection portion that is disposed on the movement portion, and detects a position of the image forming medium, a punching processing portion that is disposed on the movement portion, and that executes a punching process at a predetermined position on the image forming medium based on the position of the image forming medium detected by the position detection portion, and a control portion that controls the conveying portion to stop the conveying of the image forming medium when it is detected by the position detection portion that the image forming medium is positioned on an abnormal conveying path that diverges from a region on a normal conveying path within the conveying path region.

According to the present invention, a post-processing apparatus can be provided that enables suppression of jamming of an image forming medium such as a paper sheet or the like. Furthermore, according to the present invention, an image forming apparatus can be provided that includes the post-processing apparatus.

### BRIEF DESCRIPTION OF THE DRAWINGS

FIG. 1 describes the overall configuration of a copying apparatus according to a first embodiment of an image forming apparatus.

FIG. 2 is a block diagram showing the functional configuration of the copying apparatus.

FIG. 3A shows the detection of the paper sheet.

FIG. 3B shows the detection of the paper sheet.

FIG. 3C shows the detection of the paper sheet.

FIG. 4 is a flowchart showing the operation of a post-processing apparatus.

### DETAILED DESCRIPTION OF THE INVENTION

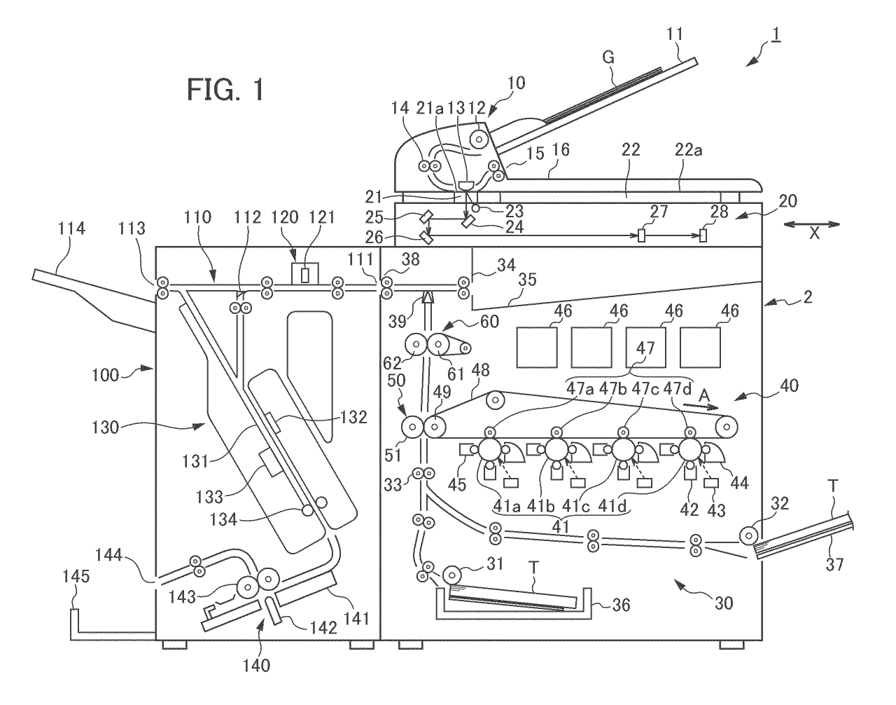

A copying apparatus 1 of a first embodiment of the image forming apparatus according to the present invention will be described below making reference to the figures. Firstly, the overall configuration of the copying apparatus 1 will be described. FIG. 1 describes the overall configuration of a copying apparatus 1 according to a first embodiment of the image forming apparatus.

The copying apparatus 1 includes a copying apparatus main body forming a toner image on paper sheet T (image forming apparatus main body) 2, and a post-processing apparatus 100. The post-processing apparatus 100 is disposed on the sheet discharge side of the copying apparatus main body 2, and executes punching processing, stapling processing, and center-folding processing of the paper sheet (image forming medium) on which the toner image is formed. The copying apparatus main body 2 includes a original conveying portion 10, a original reader portion 20, a first sheet conveying portion 30, an image forming portion 40, a transfer portion 50, and a fixing portion 60.

The original conveying portion 10 is composed by an ADF (auto document feeder), and includes a original mounting portion 11, a first roller 12, a guide 13, a timing roller pair 14, and a original discharge portion 15. The first roller 12 supplies a original G mounted on the original mounting portion 11 in order of single sheets to the timing roller pair 14. The timing roller pair 14 conveys the original G or stops the conveyance of the original G in order to make the timing of the reading of the original G by the original reader portion 20 coincide with the timing of supplying the original G to the position for reading of the original G by the original reader portion 20 (position at which the guide 13 is disposed). The guide 13 introduces the conveyed original G to the first reading surface 21a as described above. The original discharge portion 15 discharges a original G read by the original reader portion 20 (passed through the guide 13) to an external portion of the copying apparatus main body 2. A original integration portion 16 is formed on an outer side of the copying apparatus main body 2 in the original discharge portion 15. A originals G discharged from the original discharge portion 15 is stacked and collected in the original integration portion 16.

The original reader portion 20 includes a first reading surface 21a and a second reading surface 22a. The first reading surface 21a is formed along the upper surface of a first contact glass 21 disposed facing the guide 13, and forms the reading surface for the original G. The second reading surface 22a is disposed adjacent to the first reading surface 21a (as shown in FIG. 1, along the majority of the right side of the first reading surface 21a). The second reading surface 22a is used when reading a original G without using the original conveying portion 10. The second reading surface 22a is formed along the upper surface of a second contact glass 22 mounting the original G, and forms the reading surface for the original G.

The original reader portion 20 includes an illumination portion 23, a first mirror 24, a second mirror 25, a third mirror 26, an imaging lens 27, and an image capture portion 28, that are provided in an inner portion of the copying apparatus main body 2. The illumination portion 23 and the first mirror 24 are disposed respectively in a sub-scanning direction X. The second mirror 25 and the third mirror 26 are disposed on the left side of the illumination portion 23 and the first mirror 24 in FIG. 1. Furthermore, the second mirror 25 and the third mirror 26 respectively displace in the sub-scanning direction X while maintaining a fixed distance (optical path length) from the first reading surface 21a or the second reading surface 22a to the image capture portion 27, the distance being from the first mirror 24, the second mirror 25, the third mirror 26, to the imaging lens 27.

The illumination portion 23 is a light source that illuminates light onto the original G. The first mirror 24, the second mirror 25, and the third mirror 26 are mirrors that maintain a fixed optical path length while introducing light reflected by the original G to the imaging lens 27. The imaging lens 27 images light that is incident from the third mirror 26 onto the image capture portion 28. The image capture portion 28 includes a plurality of image capturing elements arrayed along the main scanning direction (a direction that is orthogonal to the sub-scanning direction X). The image capturing elements are elements for obtaining image data based on a focused light image by converting the incident light to an electrical signal, and for example may be a charge coupled device (CCD), or the like.

The first sheet conveying portion 30 includes a second roller 31, a third roller 32, a registration roller pair 33, a changeover portion 39, a first sheet discharge portion 34, and a second sheet discharge portion 38. The second roller 31 supplies a paper sheet T (transfer medium) contained in the sheet cassette 36 to the transfer portion 50. The third roller 32 supplies a paper sheet T mounted on the manual feed tray 37 to the transfer portion 50. The registration roller pair 33 conveys the paper sheet T or stops the conveyance of the paper sheet T in order to make the timing of the forming of a toner image on the transfer portion 50 coincide with the timing of supplying the paper sheet T to the transfer portion 50. The registration roller pair 33 corrects skew (inclination of the supplied paper sheet) of the paper sheet T. The changeover portion 39 switches the conveying direction of the paper sheet T so that the paper sheet T is conveyed from the fixing portion 60 to one of the first sheet discharge portion 34 and the second sheet discharge portion 38. The first sheet discharge portion 34 and the second sheet discharge portion 38 discharge a paper sheet T having a toner image fixed thereto to an external portion of the copying apparatus main body 2. A discharged sheet integration portion 35 is formed on an outer side of the copying apparatus main body 2 in the first sheet discharge portion 34. A paper sheet T discharged from the first sheet discharge portion 34 is stacked and collected in the discharged sheet integration portion 35.

The image forming portion 40 includes a photosensitive drum 41, a charging portion 42, a laser scanning unit 43, a developing unit 44, a cleaning portion 45, a toner cartridge 46, a primary transfer roller 47, an intermediate transfer belt 48, and a counter roller 49. The photosensitive drum 41 (41a, 41b, 41c, 41d) functions as a photosensitive body or an image bearing member to form respective toner images of black, cyan, magenta and yellow. The charging portion 42, the laser scanning unit 43, the developing unit 44, and the cleaning portion 45 are disposed in order from upstream to downstream along the rotation direction of the photosensitive drum 41 in the periphery of each photosensitive drum 41a, 41b, 41c, and 41d. The charging portion 42 applies a charge to the surface of the photosensitive drum 41. The laser scanning unit 43 is disposed at a distance from the surface of the photosensitive drum 41, and the surface of the photosensitive drum 41 is scanned and exposed based on the image data related to the original G that is read by the original reader portion 20.

In this manner, a charge on the exposed portion on the surface of the photosensitive drum 41 is removed to thereby form an electrostatic latent image. The developing unit 44 attaches toner to the electrostatic latent image formed on the surface of the photosensitive drum 41 to thereby form a toner image. The cleaning portion 45 removes residual toner from the surface of the photosensitive drum 41 after the static charge is removed from the surface of the photosensitive drum 41 by a charge removal device (not shown). The toner cartridge 46 contains respective colors of toner supplied to the developing unit 44. The toner cartridge 46 and the developing unit 44 are connected by a toner supply passage (not shown).

The primary transfer rollers 47 (47a, 47b, 47c, 47d) are respectively disposed opposite each photosensitive drum 41a, 41b, 41c, 41d in the intermediate transfer belt 48. The intermediate transfer belt 48 is a belt passing through the image forming portion 40 and the transfer portion 50. A part of the intermediate transfer belt 48 is sandwiched between each photosensitive drum 41a, 41b, 41c, 41d and each primary transfer roller 47a, 47b, 47c, 47d. Primary transfer of a toner image formed on the surface of each photosensitive drum 41a, 41b, 41c, 41d is executed onto the intermediate transfer belt 48. The counter roller 49 is a drive roller disposed on an inner side of the annular intermediate transfer belt 48, and propels the intermediate transfer belt 48 in the direction A of the arrow as shown in FIG. 1.

The transfer portion 50 includes a secondary transfer roller 51. The secondary transfer roller 51 is disposed opposite the counter roller 49 in the intermediate transfer belt 48, and sandwiches a portion of the intermediate transfer belt 48 with the counter roller 49. The secondary transfer roller 51 executes secondary transfer onto the paper sheet T using the toner image that has been subjected to primary transfer on the intermediate transfer belt 48.

The fixing portion 60 includes a heating rotational member 61 and a pressuring rotational member 62. The heating rotational member 61 and the pressuring rotational member 62 sandwich the paper sheet T that includes the secondary-transfer toner image, to thereby melt and pressurize the toner, and fix the toner onto the paper sheet T.

The post-processing apparatus 100 includes a second sheet conveying portion 110 as a conveying portion, a punching portion 120, a stapling portion 130, and a center-folding portion 140. The second sheet conveying portion 110 includes a carrying-in portion 111, a branch guide 112, and a first discharge portion 113. The carrying-in portion 111 inputs a paper sheet T discharged from the second sheet discharge portion 38 of the copying apparatus main body 2 into an inner portion of the post-processing apparatus 100, and conveys the paper sheet T to the punching portion 120. The branch guide 112 switches the conveying direction of the paper sheet T discharged from the punching portion 120 to one of the first discharge portion 113 and the stapling portion 130. The first discharge portion 113 discharges the paper sheet T that is discharged from the punching portion 120 and the paper sheet T that is discharged from the stapling portion 130 from the post-processing apparatus 100. A main tray 114 is disposed on an outer side of the post-processing apparatus 100 in the first discharge portion 113. The paper sheet T that is discharged from the first discharge portion 113 is stacked and collected in the main tray 114. The punching portion 120 executes a series of processing operations in relation to punching processing (processing that forms a hole used for binding of the paper sheet T at a predetermined position of the paper sheet). The punching portion 120 will be described in detail hereafter.

The stapling portion 130 fixes by stapling (staple process) the paper sheet T with a staple (binding pin), and includes a sheet receiving plate 131, a holding portion 132, a stapling processing portion 133, and a conveying roller 134. The sheet receiving plate 131 temporarily holds a plurality of paper sheets T that are input from the punching portion 120 by switching the branching guide 112. The holding portion 132 receives, immobilizes and retains a lower end of the paper sheet T input to the sheet receiving plate 131. The stapling processing portion 133 moves to near to the end or near to the center of the paper sheet T temporarily held on the sheet receiving plate 131, and performs a stapling process near to the end or near to the center of the paper sheet T. The conveying roller 134 conveys a sheet bundle, that has been stapling processed near to the center of the paper sheet T, from the sheet receiving plate 131 to the center-folding portion 140.

The center-folding portion 140 folds a bound sheet bundle from near to the center (center-folding processing), and includes a center-folding plate 141, a pressing portion 142, a center-folding roller pair 143, and a second discharge portion 144. The center-folding plate 141 mounts the bound sheet bundle with the stapling portion 130. The pressing portion 142 is provided to displace in a direction that is orthogonal to the sheet bundle mounted on the center-folding plate 141. The pressing portion 142 presses a portion near to the center of the sheet bundle (the portion that has been staple processed) towards the center-folding roller pair 143 disposed on the opposite side to the pressing portion 142 relative to the sheet bundle by displacing towards the sheet bundle. The center-folding roller pair 143 folds the sheet bundle pressed by the pressing portion 142 into a book-bound state, and conveys the folded sheet bundle to the second discharge portion 144. The second discharge portion 144 discharges the folded paper sheet T from the post-processing apparatus 100. A discharge tray 145 is disposed on an outer side of the post-processing apparatus 100 in the second discharge portion 144. A sheet bundle discharged from the second discharge portion 144 is collected in the discharge tray 145.

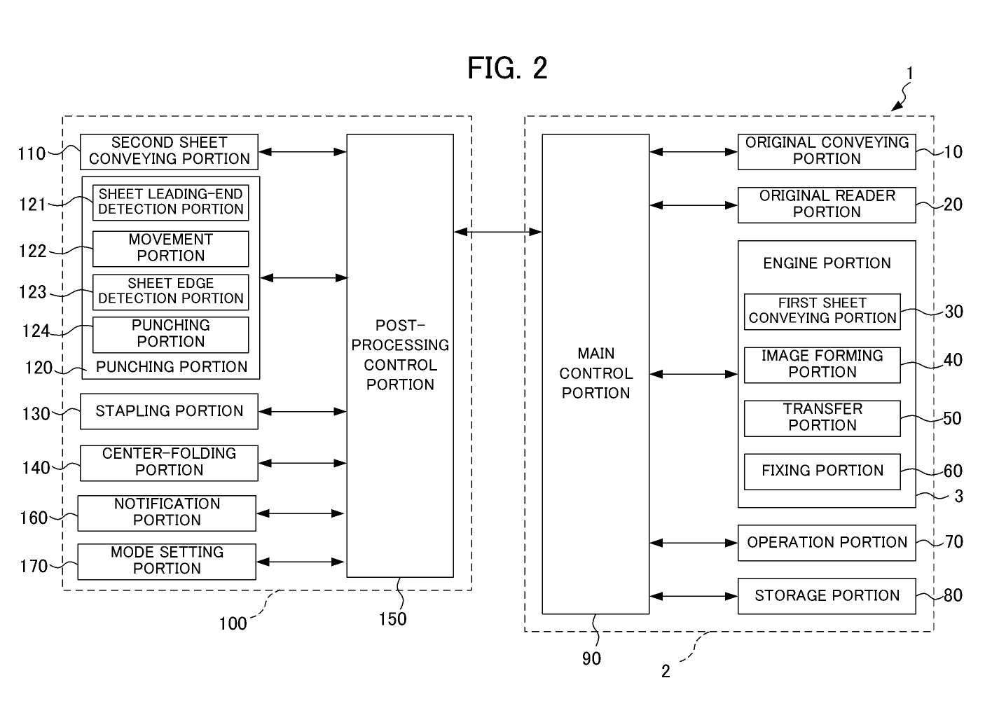

Next, the functional configuration of the copying apparatus 1 will be described below. FIG. 2 is a block diagram showing the functional configuration of the copying apparatus 1. The copying apparatus main body 2 includes the constituent elements as described above (the original conveying portion 10, the original reader portion 20, the first sheet conveying portion 30, the image forming portion 40, the transfer portion 50, and the fixing portion 60). An engine portion 3 is configured from the first sheet conveying portion 30, the image forming portion 40, the transfer portion 50, and the fixing portion 60. Description of constituent elements that have been described with reference to FIG. 1 will be omitted. In addition to the functional configuration above, the copying apparatus main body 2 further includes an operation portion 70, a memory portion 80, and a main control portion 90.

The operation portion 70 includes a numeric keypad (not shown), a touch panel (not shown), a start key (not shown), and the like. The numeric keypad is operated for input of numerals related to print copy number and the like. The touch pad displays a plurality of keys or the like that are allocated to various functions (for example, a setting function for the copy magnification, a function for allocating a plurality of pages to a single sheet T (2in1), a function of executing a punching process, a stapling process, or a center-folding process, or the like). The keys displayed on the touch panel is operated (by touch) in order to execute any of the various functions on the copying apparatus 1. The start key is operated to execute printing. In response to operation of any of the keys, the operation portion 70 supplies a signal expressing operation of the key to the main control portion 90.

The memory portion 80 is configured from a hard disk, a semiconductor memory, or the like. The memory portion 80 stores image data based on the original G read by the original reader portion 20. The memory portion 80 stores control programs used in the copying apparatus 1 and data used in relation to these control programs.

The main control portion 90 controls the original conveying portion 10, the original reader portion 20, the engine portion 3, the touch panel that configures the operation portion 70, and the post-processing control portion 150 functioning as a control portion.

The post-processing apparatus 100 includes the constituent elements described above (the second sheet conveying portion 110, the punching portion 120, the stapling portion 130, and the center-folding portion 140). Description of constituent elements that have been described with reference to FIG. 1 will be omitted. In addition to the constituent elements above, the post-processing apparatus 100 includes a notification portion 160, a mode setting portion 170, and a post-processing control portion 150. The notification portion 160 executes notification in response to control from the post-processing control portion 150. More specifically, the notification of the notification portion 160 may be executed by outputting a sound from a speaker (not shown) or by display of a warning on the touch panel.

The mode setting portion 170 sets whether or not punching processing will be performed by the punching processing portion 124 described below. More specifically, the modes set by the mode setting portion 170 include a punching mode or a non-punching mode. The punching mode is a mode in which punching processing is performed by the punching processing portion 124. The non-punching mode is a mode in which punching processing is not performed by the punching processing portion 124. When set in non-punching mode, the movement portion 122 displaces so that the punching processing portion 124 is retracted to a position separated from the position at which punching processing is performed. The sheet edge detection portion 123 displaces onto an abnormal conveying path R2 described below as a result of the displacement of the punching processing portion 124 by the movement portion 122.

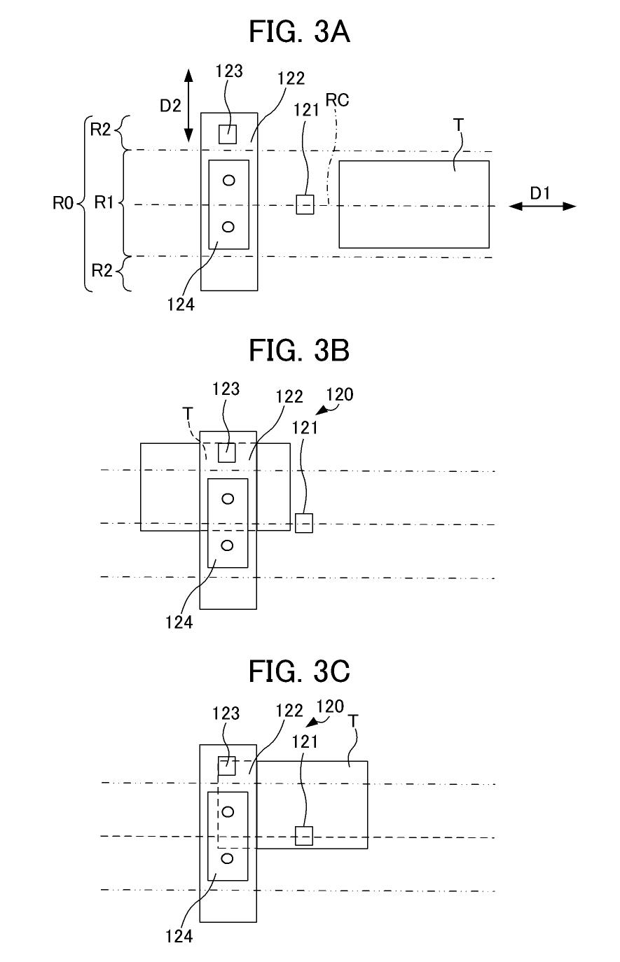

Detailed description of the punching portion 120 will be given below making reference to FIG. 2 and FIG. 3A to FIG. 3C. As shown in FIG. 2, the punching portion 120 includes a sheet leading-end detection portion 121, a movement portion 122, a sheet edge detection portion (position detection portion) 123 provided on the movement portion 122, and a punching processing portion 124 provided on the movement portion 122.

The sheet leading-end detection portion 121 is configured for example from an optical sensor that detects the paper sheet T when irradiated light is obstructed. The sheet leading-end detection portion 121 detects the leading end of the paper sheet T when the paper sheet T conveyed by the second sheet conveying portion 110 is disposed below the sheet leading-end detection portion 121. The movement portion 122 displaces in a displacement direction that is different from the conveying direction D1 of the paper sheet T on the second sheet conveying portion 110. In the present embodiment, the movement portion 122 displaces in a direction that is orthogonal (orthogonal direction) D2 to the conveying direction D1 of the paper sheet T. The movement portion 122 displaces in the orthogonal direction D2 to displace the sheet edge detection portion 123 and the punching processing portion 124 provided on the movement portion 122 in the orthogonal direction D2.

The sheet edge detection portion 123 is configured for example from an optical sensor that detects the paper sheet T when irradiated light is obstructed. The sheet edge detection portion 123 detects the edge of the paper sheet T and detects the position of the paper sheet T on the conveying path RO for the paper sheet T when the paper sheet T conveyed on the second sheet conveying portion 110 is positioned below the sheet edge detection portion 123. The conveying path RO as shown in FIG. 3A means the region (path) in which the paper sheet T is conveyed by the second sheet conveying portion 110.

The sheet edge detection portion 123 as shown in FIG. 3A is displaced in the orthogonal direction D2 by the displacement of the movement portion 122 in the orthogonal direction D2. The punching processing portion 124 is provided to displace in a vertical direction relative to the paper sheet T. The punching processing portion 124 is configured from a punching blade that forms holes in the paper sheet T by passing through the paper sheet T.

The punching processing portion 124 forms a hole in the paper sheet T by displacing the punching processing portion 124 in a vertical direction and thereby passing the punching blade through the paper sheet T when the conveyed paper sheet T has stopped below the punching processing portion 124. The punching processing portion 124 as shown in FIG. 3A displaces in the orthogonal direction D2 as a result of displacement of the movement portion 122 in the orthogonal direction D2.

In the above configuration, the post-processing control portion 150 controls the second sheet conveying portion 110 so that the conveying of the paper sheet T is stopped when it is detected that the paper sheet T is jammed and is positioned on the abnormal conveying path R2. The abnormal conveying path R2 is a region in which there is a possibility of a conveyance abnormality (an abnormality in which the paper sheet T cannot be discharged to the outside of the post-processing apparatus 100). The abnormal conveying path R2 is a region in which there is a possibility of a paper sheet T that has diverging from the region of a normal conveying path R1 within the conveying path region RO not being capable of discharge to the outside of the post-processing apparatus 100. In this regard, the normal conveying path R1 as shown in FIG. 3A is the region in which a punching processing can be performed at a predetermined position on the paper sheet T within the range of the conveying path RO, and in which the paper sheet T can be discharged out of the post-processing apparatus 100. That is to say, as shown in FIG. 3A, the normal conveying path R1 is a region in which punching processing can be performed by the punching processing portion 124 at a position in which the conveying center RC coincides with the center of the paper sheet T (the region in which the center of the paper sheet T deviates slightly from the conveying center RC).

The sheet edge detection portion 123 uses the detection position of the edge of the paper sheet T in order to detect whether the paper sheet T is positioned on the normal conveying path R1, or whether it is positioned on the abnormal conveying path R2.

Next, the operation of the copying apparatus 1 will be described (when copying and post-processing a original G mounted on the original mounting portion 11). The main control portion 90 detects that the start key has been operated by supply of a signal showing that the start key configuring the operation portion 70 has been operated. Then the main control portion 90 drives the first roller 12 of the original conveying portion 10 and supplies the original G to the first reading surface 21a. The main control portion 90 generates image data with the original reader portion 20 based on the original G supplied to the first reading surface 21a, and temporarily stores the image data in the memory portion 80. The main control portion 90 forms a toner image on the paper sheet T based on the image data temporarily stored in the memory portion 80 by respectively controlling the first sheet conveying portion 30, the image forming portion 40, the transfer portion 50, and the fixing portion 60 that configure the engine portion 3. In other words, the main control portion 90 drives the second roller 31 or the third roller 32 to convey the paper sheet T to the transfer portion 50. The main control portion 90 supplies data for an image that is produced in each color based on the image data to the respective laser scanning units 43 to thereby form an electrostatic latent image on the photosensitive drum 41 using the laser light irradiated from the laser scanning units 43. The main control portion 90 forms a toner image on the photosensitive drum 41 using the developing unit 44, and the toner image is subjected to primary transfer onto the intermediate transfer belt 40. The main control portion 90 uses the secondary transfer roller 51 to perform secondary transfer of the toner image from the intermediate transfer belt 48 onto the paper sheet T of primary-transfer image. The main control portion 90 performs control so that the heating rotational member 61 is heated to a predetermined temperature to thereby melt the toner on the secondary-transfer toner image onto the paper sheet T with the heating rotation member 61, and fixes the toner to the paper sheet T with the pressuring rotation member 62 that is pressured into contact by the heating rotation member 61. The main control portion 90 uses the first sheet conveying portion 30 to discharge the paper sheet T with the toner image fixed thereto from the second sheet discharge portion 38.

The main control portion 90 controls the post-processing control portion 150 to execute post-processing on the paper sheet T that is discharged from the second sheet discharge portion 38. The post-processing control portion 150 uses the second sheet conveying portion 110 to input the paper sheet T discharged from the second sheet discharge portion 38 to the post-processing apparatus 100.

The sheet edge detection portion 123 detects the position of the paper sheet T on the conveying path RO when punching mode is set by the mode setting portion 170. The post-processing control portion 150 stops the conveying of the paper sheet T by the second sheet conveying portion 110 at the punching portion 120 when the sheet edge detection portion 123 detects that the paper sheet T is on a normal conveying path R1.

The post-processing control portion 150 lowers the punching processing portion 124 of the punching portion 120 towards the paper sheet T to form a punching hole in the paper sheet T. The post-processing control portion 150 conveys the paper sheet T with a punching hole formed therein with the second sheet conveying portion 110, and discharges the paper sheet T from the first discharge portion 113. Conversely, when the paper sheet T is detected to be on an abnormally conveying path R2, the post-processing control portion 150 stops the conveying of the paper sheet T by the second sheet conveying portion 110 and performs a notification via the notification portion 160.

When a punching mode is set by the mode setting portion 170, the post-processing control portion 150 uses the sheet edge detection portion 123 that is positioned on the abnormally conveying path R2 to detect the paper sheet T. When the paper sheet T is detected, the post-processing control portion 150 stops the conveying of the paper sheet T by the second sheet conveying portion 110, and performs a notification via the notification portion 160. When the paper sheet T is not detected, the post-processing control portion 150 conveys the paper sheet T with a punching hole formed therein with the second sheet conveying portion 110, and discharges the paper sheet T from the first discharge portion 113.

When a stapling process is executed, the post-processing control portion 150 temporarily holds the paper sheet T on the sheet receiving plate 131 using the branching guide 112 to switch to a direction that is orthogonal to the direction of conveying of the paper sheet T input to the post-processing device 100. The post-processing control portion 150 displaces the stapling processing portion 133 when a predetermined number of paper sheets T is temporarily held on the sheet receiving plate 131. The post-processing control portion 150 uses the stapling processing portion 133 to execute a stapling process near to the end or near to the center of the paper sheet T. After a stapling process has been executed by the stapling processing portion 133 near to the end of the paper sheet T, the post-processing control portion 150 discharges the stapled sheet bundle from the first discharge portion 113. After a stapling process has been executed by the stapling processing portion 133 near to the center of the paper sheet T, the bound sheet bundle is conveyed to the center-folding portion 140 (center-folding plate 141).

When center folding is executed, the post-processing control portion 150 presses the sheet bundle towards the center-folding roller pair 143 by displacing the pressing portion 142 towards the sheet bundle that is mounted on the center-folding plate 141. Then, the post-processing control portion 150 folds the sheet bundle with the center-folding roller pair 143, and conveys the folded sheet bundle to the second discharge portion 144 for discharge from the second discharge portion 144.

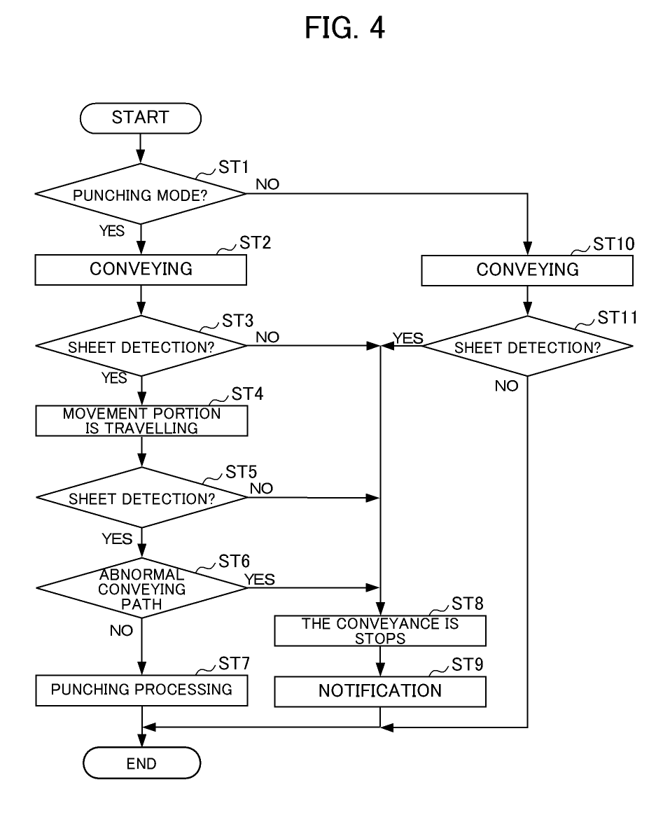

Next, the processing executed at the punching portion 120 of the post-processing apparatus 100 will be described making reference to FIG. 4. In the initial state, the movement portion 122 is on the initial position where the sheet edge detection portion 123 exists on the abnormal conveying path R2. In a step ST1, the mode setting portion 170 sets the punching mode or the non-punching mode. More specifically, the punching mode or the non-punching mode is selected by a user via the touch pad. The mode setting portion 170 sets the mode based on the selection by a user.

When the punching mode is selected (YES) in the post-processing apparatus 100, the processing proceeds to step ST2. When the punching mode is not selected in the post-processing apparatus 100, that is to say, the non-punching mode is set (NO), the processing proceeds to step ST10 as described below. Punching mode is a mode that forms a punching hole in the paper sheet T with the punching processing portion 124. In the non-punching mode, punching processing is not performed, and conveying of the paper sheet T is executed by the second sheet conveying portion 110, and the paper sheet T conveyed from the copying apparatus main body 2 is discharged from the copying apparatus 1.

In a step ST2, the second sheet conveying portion 110 conveys the paper sheet T that is conveyed from the copying apparatus main body 2. After the step ST2, the processing proceeds to step ST3.

In the step ST3, the post-processing control portion 150 determines whether or not the leading end of the paper sheet T has been detected by the sheet leading-end detection portion 121. When it is determined that the leading end of the paper sheet T has been detected (YES), the processing proceeds to a step ST4. When it is determined that the leading end of the paper sheet T has not been detected (NO), the processing proceeds to a step ST8 as described below.

In the step ST4, the movement portion 122 is displaced in the orthogonal direction D2. After the step ST4, the processing proceeds to a step ST5.

In the step ST5, the post-processing control portion 150 determines whether or not the end of the paper sheet T has been detected by the sheet edge detection portion 123. When it is determined that the edge of the paper sheet T has been detected (YES), the processing proceeds to a step ST6. When it is determined that the edge of the paper sheet T has not been detected (NO), the processing proceeds to a step ST8.

In the step ST6, the post-processing control portion 150 determines whether or not the edge of the paper sheet T has been detected on the abnormal conveying path R2 by the sheet edge detection portion 123. When it is determined that the detected position of the edge of the paper sheet T is not on the abnormal conveying path R2, that is to say, it is on the normal conveying path R1 (NO), the processing proceeds to a step ST7. When it is determined that the detected position of the edge of the paper sheet T is on the abnormal conveying path R2 (YES), the processing proceeds to a step ST8.

In the step ST7, the punching processing portion 124 executes punching processing at the predetermined position on the paper sheet T. Thereafter, as shown in FIG. 3A, the paper sheet T is positioned on the correct conveying path R1 in the post-processing apparatus 100. As a result, the paper sheet T in the post-processing apparatus 100 is discharged by the second sheet conveying portion 110, and processing is completed. More specifically, the punching processing portion 124 forms a punching hole at a predetermined position on the paper sheet T by displacing the movement portion 122 and adjusting the punching position based on the position of the paper sheet T on the normal conveying path R1 detected by the sheet edge detection portion 123. Thereafter, conveying is performed by the second sheet conveying portion 110 in the post-processing apparatus 100, and the paper sheet T is discharged out of the post-processing apparatus 100. The movement portion 122 returns to the initial position where the sheet edge detection portion 123 exists on the abnormal conveying path R2. In this manner, the processing is completed.

In the step ST8, the post-processing control portion 150 performs control to stop the conveying of the paper sheet T by the second sheet conveying portion 110, and the conveying of the paper sheet T is stopped. At this time, the post-processing apparatus 100 determines that the leading end of the paper sheet T has not been detected in the step ST3, and that a normal state does not exist, such as the paper sheet T has not yet been conveyed. As a result, the post-processing control portion 150 controls the second sheet conveying portion 110 to stop the conveying of the paper sheet T. As a result, the conveying of the paper sheet T is stopped.

Since the edge of the paper sheet T in the step ST5 has not been detected in the post-processing apparatus 100, there is the possibility that the paper sheet T is on the abnormal conveying path R2. As a result, the post-processing control portion 150 controls the second sheet conveying portion 110 to stop the conveying of the paper sheet T. As a result, the conveying of the paper sheet T is stopped.

Since it is determined in the step ST6 that the paper sheet T is detected on the abnormal conveying path R2, the state in the post-processing apparatus 100 is shown in FIG. 3B. As a result, the post-processing control portion 150 controls the second sheet conveying portion 110 to stop the conveying of the paper sheet T. In the above state, the post-processing control portion 150 can suppress jamming of the paper sheet T by controlling the second sheet conveying portion 110 to stop the conveying of the paper sheet T. After the step ST8, the processing proceeds to a step ST9.

In the step ST9, the post-processing control portion 150 performs notification via the notification portion 160. That is to say, the post-processing apparatus 100 executes a notification via the notification portion 160 to evoke a warning to a user that the conveying of the paper sheet T in the step ST8 is stopped. In this manner, the processing is completed. The movement portion 122 returns to the initial position where the sheet edge detection portion 123 exists on the abnormal conveying path R2 when the movement portion 122 is displaced in the step ST4, and the processing is completed.

When the non-punching mode is set in the step ST1 (NO), in a step ST10, the second sheet conveying portion 110 conveys the paper sheet T in the non-punching mode setting state. After the step ST10, the processing proceeds to a step ST11.

In step ST11, the post-processing control portion 150 determines whether or not the edge of the paper sheet T has been detected by the sheet edge detection portion 123. When the end of the paper sheet T has been detected (YES), the processing in the post-processing apparatus 100 proceeds to a step ST8. That is to say, the processing proceeds to the step ST8 when it is determined that the edge of the paper sheet T is detected by the sheet edge detection portion 123 (YES) in a state in which the movement portion 122 for setting of non-punching mode has not displaced (stationary state). When the edge of the paper sheet T is not detected (NO), the processing in the post-processing apparatus 100 is completed. That is to say, the conveying operation by the second sheet conveying portion 110 is continued, and the paper sheet T is discharged out of the copying apparatus 1.

In the step ST8, the post-processing control portion 150 performs control to stop the conveying of the paper sheet T by the second sheet conveying portion 110, and stops the conveying of the paper sheet T. The post-processing apparatus 100 is in a state in which it is determined that the edge of the paper sheet T has been detected in a state of not moving (stationary state) in the step ST11. That is to say, the paper sheet T is in a position on the abnormal conveying path R2, and is in the state as shown in FIG. 3C. As a result, the post-processing control portion 150 controls the second sheet conveying portion 110 to stop the conveying of the paper sheet T. As a result, the conveying of the paper sheet T is stopped. After the step ST8, the processing proceeds to the step ST9.

In the step ST9, the post-processing control portion 150 executes notification via the notification portion 160. That is to say, the post-processing apparatus 100 executes a notification via the notification portion 160 to evoke a warning to a user that the conveying of the paper sheet T in the step ST9 has stopped. In this manner, the processing is completed.

Thus, when the paper sheet T is detected on the abnormal conveying path R2 in the post-processing apparatus 100 in the present embodiment, jamming of the paper sheet T can be suppressed by stopping the conveying of the paper sheet T.

The following effects are obtained in the post-processing apparatus 100 of the copying apparatus 1 according to the present embodiment. The post-processing apparatus 100 according to the present embodiment includes a post-processing control portion 150 that controls the second sheet conveying portion 110 to stop the conveying of the paper sheet T, when the position of the paper sheet T detected by the sheet edge detection portion 123 is detected at a position on the abnormal conveying path R2. Thus the post-processing apparatus 100 of the copying apparatus 1 according to the present embodiment can detect in advance a state in which there is a possible of jamming of the paper sheet T, and therefore jamming of the paper sheet T can be suppressed by stopping the conveying of the paper sheet in accordance with this detection.

According to the present embodiment, when the paper sheet T is detected set in non-punching mode, and in a state in which the movement portion 122 does not displace, the paper sheet T is positioned on the abnormal conveying path R2 in which there is a possibility of jamming of the paper sheet T. In this case, the post-processing control portion 150 performs control the stop the conveying of the second sheet conveying portion 110. As a result, the second sheet conveying portion 110 stops conveying operations. Thus the post-processing apparatus 100 of the copying apparatus 1 according to the present embodiment can suppress jamming of the paper sheet T since a paper sheet T that is conveyed in a region in which there is a possibility of jamming of the paper sheet T can be detected.

According to the present embodiment, when the conveying of the paper sheet T by the second sheet conveying portion 110 is stopped, the post-processing control portion 150 controls the notification portion 160 to perform a notification that the paper sheet T is positioned on the abnormal conveying path R2. As a result, the post-processing apparatus 100 of the copying apparatus 1 in the present embodiment can notify that there is a possibility of jamming of the paper sheet T to a user in the absence of jamming of the paper sheet T.

The preferred embodiments of the post-processing apparatus 100 of the copying apparatus 1 according to the present invention have been described above. However the post-processing apparatus 100 of the copying apparatus 1 according to the present invention is not thereby limited to such embodiment, and may be executed in various aspects.

Although the control of the second sheet conveying portion 110 in the post-processing apparatus 100 of the copying apparatus 1 according to the present embodiment was executed by the post-processing control portion 150, the invention is not thereby limited. The post-processing apparatus 100 of the copying apparatus 1 may control the second sheet conveying portion 110 for example with the main control portion 90 of the copying apparatus main body 2.

Although the copying apparatus 1 according to the present embodiment is a color copying apparatus. However there is no limitation to this configuration, and it may be a monochrome copying apparatus.

The copying apparatus 1 according to the present embodiment transfers a toner image onto paper sheet T via the intermediate transfer belt 48 (indirect transfer configuration). However there is no limitation to this configuration, and the toner image formed by the photosensitive drum may be directly transferred onto the paper sheet T (direct transfer configuration). The copying apparatus 1 according to the present embodiment is configured to print on one side of the paper sheet T. However there is no limitation to this configuration, and double-sided printing of the sheet may be executed.

The image forming apparatus according to the present invention is not limited to the copying apparatus 1 above. In other words, the image forming apparatus according to the present invention may relate to a multifunction peripheral combining a copying function, a facsimile function, a printer function, and a scanning function, or may be a facsimile or a printer. Furthermore the transfer medium that fixes the toner image with the image forming apparatus according to the present invention is not limited to a paper sheet T, and may include for example, a plastic sheet for an OHP (overhead projector) sheets, or the like.

What is claimed is:

1. A post-processing apparatus that executes a punching process at a predetermined position of an image forming medium, the medium discharged from an image forming apparatus main body that executes forming of an image, the post-processing apparatus comprising:
a conveying portion that conveys the image forming medium;
a movement portion that displaces in a displacement direction that is different from the conveying direction of the image forming medium on the conveying portion;
a position detection portion that is disposed on the movement portion, and detects a position of the image forming medium;
a punching processing portion that is disposed on the movement portion, and that executes a punching process at a predetermined position on the image forming medium based on the position of the image forming medium detected by the position detection portion; and
a control portion that controls the conveying portion to stop the conveying of the image forming medium when the position detection portion detects that the image forming medium is positioned on an abnormal conveying path that diverges from a region on a normal conveying path within a conveying path region.

2. The post-processing apparatus according to claim 1 further comprising a mode setting portion that sets a punching mode in which the punching processing portion is operated, and a non-punching mode in which the punching processing portion is not operated; and
wherein when punching mode is set by the mode setting portion, the control portion controls the conveying portion to stop the conveying of the image forming medium when the movement portion is displaced, and the position detection portion that is disposed on the movement portion does not detect the image forming medium as a result of the displacement of the movement portion.

3. The post-processing apparatus according to claim 1 further comprising a mode setting portion that sets a punching mode in which the punching processing portion is operated, and a non-punching mode in which the punching processing portion is not operated; and
wherein when punching mode is set by the mode setting portion, the control portion controls the conveying portion to stop the conveying of the image forming medium when the movement portion is displaced, and the position detection portion that is disposed on the movement portion detects, by reason of the displacement of the movement portion, that the image forming medium is positioned on the abnormal conveying path that diverges from a region on the normal conveying path within the conveying path region.

4. The post-processing apparatus according to claim 1 further comprising a mode setting portion that sets a punching mode in which the punching processing portion is operated, and a non-punching mode in which the punching processing portion is not operated; and
wherein when non-punching mode is set by the mode setting portion, the control portion controls the conveying portion to stop the conveying of the image forming medium when the movement portion is in a stationary state and the image forming medium is detected by the position detection portion that is disposed on the movement portion.

5. The post-processing apparatus according to claim 1 wherein the movement portion displaces in a direction that is orthogonal to the conveying direction of the image forming medium.

6. The post-processing apparatus according to claim 1 wherein the position detection portion uses the detected position of a edge of the image forming medium in a direction that is orthogonal to the conveying direction to detect whether the image forming medium is positioned on the normal conveying path, or whether it is positioned on the abnormal conveying path.

7. The post-processing apparatus according to claim 1 further comprising a leading-edge detection portion that detects the leading edge in the conveying direction of the image forming medium that is discharged from the image forming apparatus that executes image formation; and
wherein the control portion displaces the movement portion in a displacement direction that is different to the conveying direction of the image forming medium when the leading edge of the image forming medium is detected by the leading-edge detection portion.

8. The post-processing apparatus according to claim 1 further comprising a notification portion that notifies that the image forming medium is positioned on the abnormal conveying path; and
wherein the control portion controls the notification portion to notify that the image forming medium is positioned on the abnormal conveying path, when conveying of the image forming medium is stopped by the conveying portion.

9. An image forming apparatus including an image forming apparatus main body that executes formation of an image, and a post-processing apparatus that executes a punching process to open a hole at a predetermined position of an image forming medium, the medium discharged from the image forming apparatus main body, the image forming apparatus comprising;
a conveying portion that conveys the image forming medium from the image forming apparatus main body;
a movement portion that displaces in a displacement direction that is different from the conveying direction of the image forming medium on the conveying portion;
a position detection portion that is disposed on the movement portion, and detects a position of the image forming medium;
a punching processing portion that is disposed on the movement portion, and that executes a punching process at a predetermined position on the image forming medium based on the position of the image forming medium detected by the position detection portion; and
a control portion that controls the conveying portion to stop the conveying of the image forming medium when the position detection portion detects that the image forming medium is positioned on the abnormal conveying path that diverges from a region on the normal conveying path within the conveying path region.

10. An image forming apparatus including an image forming apparatus main body that executes formation of an image, and a post-processing apparatus that executes a punching process at a predetermined position of an image forming medium, the medium discharged from the image forming apparatus main body,
wherein the image forming apparatus main body comprising;
an image forming portion that forms a toner image based on image data;
a transfer portion that transfers the toner image formed on the image forming portion to the image forming medium;
a fixing portion that fixes the toner image transferred to the image forming medium onto the image forming medium; and
a first conveying portion that supplies the image forming medium to the transfer portion, and conveys the image forming medium through the fixing portion to the post-processing device; and
wherein the post-processing device comprising;
a second conveying portion that conveys the image forming medium from the image forming apparatus main body;
a movement portion that displaces in a displacement direction that is different from the conveying direction of the image forming medium in the second conveying portion;
a position detection portion that is disposed on the movement portion, and detects a position of the image forming medium; and
a punching processing portion that is disposed on the movement portion, and that executes a punching process at a predetermined position on the image forming medium based on the position of the image forming medium detected by the position detection portion; and
the image forming apparatus further comprising; a control portion that controls the second conveying portion to stop the conveying of the image forming medium when the position detection portion detects that the image forming medium is positioned on the abnormal conveying path that diverges from a region on the normal conveying path within the conveying path region.
